(19) United States
(12) Patent Application Publication
(10) Pub. No.: US 2018/0351157 A1
(43) Pub. Date: Dec. 6, 2018

(54) COATED METAL ION BATTERY MATERIALS

(71) Applicant: Sharp Kabushiki Kaisha, Osaka (JP)

(72) Inventors: Emma KENDRICK, North Warnborough (GB); Katherine Louise SMITH, Oxford (GB)

(21) Appl. No.: 15/613,534

(22) Filed: Jun. 5, 2017

(51) Int. Cl. H01M 4/04; H01M 4/13; H01M 4/66

(52) U.S. Cl. CPC H01M 4/045; H01M 4/0404; H01M 4/0407; H01M 10/0525; H01M 4/661; H01M 4/667; H01M 4/13

(57) ABSTRACT

A coated metal ion containing material, includes a core comprising a metal ion containing material and a hydrophobic coating at least partially coating the core. A method of forming a coated metal ion containing material includes: combining the metal ion containing material and one or more hydrophobic coating materials; and milling the metal ion containing material and the one or more hydrophobic coating materials to coat the metal ion containing material with the one or more hydrophobic coating materials to provide a core comprising the metal ion containing material and a hydrophobic coating at least partially coating the core.

### TECHNICAL FIELD

The present disclosure relates to the stabilisation to air of compounds which are utilised as active materials (e.g., cathodes or anodes) for metal ion batteries, and methods of preparation thereof. The present disclosure also relates to electrodes which utilise said active material, and to the use of these electrodes, for example, in rechargeable batteries and other energy storage devices.

### BACKGROUND ART

Metal ion batteries, in particular lithium-ion batteries, are energy storage devices which have a wide array of applications. Two exemplary applications are portable battery technologies for electronic devices and automotive. Both of these applications require high energy density battery systems. An emerging market for metal ion batteries is in stationary energy storage where energy density is not a key driver but cost and cycle life is.

Sodium-ion batteries are similar to lithium-ion batteries in that they are reusable secondary batteries that include an anode (negative electrode), a cathode (positive electrode) and an electrolyte material. Lithium and Sodium-ion batteries are both capable of storing energy, and they both charge and discharge via a similar reaction mechanism. When a sodium-ion (or lithium-ion battery) is charging, Na⁺ (or Li⁺) ions de-intercalate from the cathode and insert into the anode. Consequently, charge balancing electrons pass from the cathode through the external circuit and into the anode of the battery. During discharge the same process occurs but in the opposite direction.

For applications where cost is a key driver, sodium-ion batteries may offer a viable alternative to lithium-ion batteries. Lithium is not an abundant metal and is becoming more costly to source, whereas sodium is much more abundant than lithium. Some researchers predict that sodium-ion batteries will provide a cheaper and more sustainable technology by which to store energy into the future, particularly for large scale applications such as storing energy on the electrical grid or domestic energy storage. Nevertheless, significant developments are required in terms of materials, operating voltage, specific capacity, material stability and energy efficiency before sodium-ion batteries become competitive with existing energy storage technologies.

Many sodium-ion cathode material classes have been identified in the literature, and by far the largest body or material reported are based around the layered oxides. These materials have a nominal formula of ABO2 where A is typically a sodium-ion and B is typically a transition metal in an octahedral site, although B may consist of an array of many other elements. International Application Publication No. WO 2015177568 A1 (Kendrick et al., published Nov. 26, 2015) discloses exemplary layered oxide structured materials. A review of many other layered oxide types by Han et al., “A comprehensive review of sodium layered oxides: powerful cathodes for Na-ion batteries” (Energy Environ. Sci., 2015, 8, 81-102), highlights some of the instabilities of these layered oxides in air due to water absorption. For example, the P2 type structured Na_{0.7}MnO₂ samples have a monoclinic and orthorhombic distortion when exposed to dry and air conditions due to the incorporation of water in the layers. This change is limited by substitution, and the highly substituted P2 type materials offer higher stabilities. Layered oxides with larger sodium contents such as the O3-type structured materials also suffer from instabilities in air and it has been observed that the sodium is removed and the water incorporated in between the layers. This has been noted in particular for NaNi_{1/3}Mn_{1/3}Co_{1/3}O₂ by Sathiya et al., “Synthesis, Structure, and electrochemical Properties of the Layered Sodium Insertion Cathode Material: NaNi_{1/3}Mn_{1/3}Co_{1/3}O₂” (Chem. Mater., 2012, 24 (10), pp 1846-1853).

Lithium-ion cells are often constructed in a dry room, this is because the materials used to make a lithium-ion cell may absorb water and water is detrimental to the performance of a non-aqueous electrochemical cell. Although preferably, the cathode coatings will be performed in a dry atmosphere this is often not the case, and the electrodes may be coated outside a dry room atmosphere and then subsequently dried to remove any water before transferring to a dry room. For many lithium-ion containing materials, the maximum temperature for drying is adequate to remove the absorbed water. However sodium-ion cathodes can be much more reactive to water compared to the lithium counterparts. The sodium-ion containing materials may either decompose, or may also chemically intercalate water into the structure. Therefore the temperatures used for drying (up to ˜140° C.) are not adequate to remove the chemically bound water or reverse the decomposition process. In addition to the material stability, the absorbed and adsorbed water can have a negative effect upon the properties of an ink, and in basic environments gelling of the binding agent contained within a cathode ink or paste may occur. Sodium is much more basic than the lithium layered oxides and therefore stability of the inks is also an issue which can be improved by stabilising the cathode powder.

For sodium-ion batteries to be a viable alternative to lithium-ion batteries, similar manufacturing methods should be utilised so that the existing factories can produce either lithium or sodium-ion cells as a ‘drop-in’ technology. This means that the anode and cathode materials must be stabilised to air. Several methods have been investigated to stabilise lithium-ion anodes and cathodes. These include the following:

European Patent Application EP 2073946 B1 (Yakoleva et al., published Dec. 8, 2010) discusses the stabilisation of a lithium metal anode and a method of forming lithium dispersion wherein the lithium metal powder is stabilised by a wax coating and dispersed in the host material.

United States Patent Application Publication No. US 2016/0126539 A1 (Ravet et al., published May 5, 2016) discloses a carbon-treated complex oxide having a very low water content and its use as cathode material.

United States Patent Application Publication No. US 2014/0079996 A1 (Zou et al., Mar. 20, 2014) discusses the coating of lithium-ion cathodes with binders such as polyvinylidene fluoride (PVDF) and polytetrafluoroethylene (PTFE) to increase the environmental stability. The details are specific for LiNiO₂ cathode and hydrophobic polymer.

Chen et al., “Role of surface coating on cathode materials for lithium-ion batteries” (J. Mater. Chem., 2010, 20, 7606-7612 | 7607) reviews various surface cathode coatings for lithium-ion batteries and discloses the use of a physical protection layer on cathode materials to suppress chemical reactions between cathode materials and non-aqueous electrolytes. The barrier described in Chen requires complete coverage of the cathode. These coatings are based upon inorganic solids and are applied using a secondary synthesis process.

International Application Publication No. WO 2013037692 A1 (Cojocaru et al., published Mar. 21, 2013) discloses a metallic protective coating on cathode active materials to allow processing in water rather than N-Methyl-2-pyrrolidone (NMP).

### CITATION LIST

### Patent Literature

WO 2015177568 A1 (Kendrick et al., published Nov. 26, 2015).

EP 2073946 B1 (Yakoleva et al., published Dec. 8, 2010).

US 2016/0126539 A1 (Ravet et al., published May 5, 2016).

US 2014/0079996 A1 (Zou et al., Mar. 20, 2014).

WO 2013037692 A1 (Cojocaru et al., published Mar. 21, 2013).

### Non Patent Literature

Han et al., “A comprehensive review of sodium layered oxides: powerful cathodes for Na-ion batteries” (Energy Environ. Sci., 2015, 8, 81-102).

Sathiya et al., “Synthesis, Structure, and electrochemical Properties of the Layered Sodium Insertion Cathode Material: NaNi_{1/3}Mn_{1/3}Co_{1/3}O₂” (Chem. Mater., 2012, 24 (10), pp 1846-1853).

Chen et al., “Role of surface coating on cathode materials for lithium-ion batteries” (J. Mater. Chem., 2010, 20, 7606-7612 | 7607).

### SUMMARY OF INVENTION

In accordance with one aspect of the present disclosure, a coated metal ion containing material includes: a core including a metal ion containing material; and a hydrophobic coating at least partially coating the core, wherein the hydrophobic coating comprises one or more of a carboxylic acid, silica, alumina, zeolite, silicon-based oil, and hydrophobic polymer.

In some embodiments, the core is a single particle.

In some embodiments, the core is an agglomerate of particles.

In some embodiments, the coating partially covers the core. In some embodiments, at least 50% of a surface of the core is covered by the hydrophobic coating.

In some embodiments, the coating completely covers the core.

In some embodiments, a thickness of the hydrophobic coating is 0.01 nm to 10 nm.

In some embodiments, the hydrophobic coating includes one or more of stearic acid, oleic acid, palmitic acid, myristic acid, oxalic acid, maleic acid, and salts thereof.

In some embodiments, the hydrophobic coating includes one or more of hydrophobic nano silica, hydrophobic nano alumia, and hydrophobic zeolite.

In some embodiments, the hydrophobic coating includes one or more of calcium stearate, sodium stearate, sodium mysterate, zinc stearate, cesium oxalate, cesium stearate, potassium oxalate, potassium stearate, silanol, silane, PTFE, PVDF, decanol, polyvinylpyrrolidone, poly(vinylpyridine), polyacrylates, polymethylacrylate, and sodium acrylate, carbon nanotubes, carbon black, and graphite.

In some embodiments, the metal ion containing material is represented by Chemical Formula (1):

Au M¹v M²w M³x O_{2±δ}

Wherein A is one or more alkali metals selected from sodium and/or potassium, or a mixture of lithium with sodium and/or potassium; M¹ includes one or more redox active metals with an oxidation state in the range +2 to +4; M² includes tin, optionally in combination with one or more metals; M³ includes one or more transition metals either alone or in combination with one or more non-transition elements selected from alkali metals, alkaline earth metals, other metals and metalloids, with an oxidation state in the range +1 to +5; wherein the oxidation state of M¹, M², and M³ are chosen to maintain charge neutrality and further wherein δ is in the range 0≤δ≤0.4; U is in the range 0.3<U<2; V is in the range 0.1≤V<0.75; W is in the range 0<W<0.75; X is in the range 0≤X<0.5; and (U+V+W+X)<4.0.

In some embodiments, the metal ion containing material includes Li₂FeS₂, NaNiO₂, NaMO₂ where M is Co, Ni, Fe, Mn, Ti, Sn, Zr or a mixture thereof, LiFEO₂, lithium iron borate, or a mixture thereof.

In accordance with another aspect of the present disclosure, a method of forming a coated metal ion containing material includes: combining the metal ion containing material and one or more hydrophobic coating materials, wherein the one or more hydrophobic coating materials comprises one or more of a carboxylic acid, silica, alumina, zeolite, silicon-based oil, and hydrophobic polymer; and milling the metal ion containing material and the one or more hydrophobic coating materials to coat the metal ion containing material with the one or more hydrophobic coating materials to provide a core including the metal ion containing material and a hydrophobic coating at least partially coating the core.

In some embodiments, a total of amount of the one or more hydrophobic coating materials is combined in an amount of 0.001 wt % to 5 wt % of the metal ion containing material.

In some embodiments, the method further includes combining a surfactant with the metal ion containing material and the one or more hydrophobic coating materials.

In some embodiments, the one or more hydrophobic coating materials includes one or more of stearic acid, oleic acid, palmitic acid, myristic acid, oxalic acid, maleic acid, and salts thereof.

In some embodiments, the one or more hydrophobic coating materials includes one or more of hydrophobic nano silica, hydrophobic nano alumia, and hydrophobic zeolite.

In some embodiments, the one or more hydrophobic coating materials includes one or more of calcium stearate, sodium stearate, sodium mysterate, zinc stearate, cesium oxalate, cesium stearate, potassium oxalate, potassium stearate, silanol, silane, PTFE, PVDF, decanol, polyvinylpyrrolidone, poly(vinylpyridine), polyacrylates, polymethylacrylate, and sodium acrylate, carbon nanotubes, carbon black, and graphite

In some embodiments, the metal ion containing material is represented by Chemical Formula (1):

Au M¹v M²w M³x O_{2±δ}

wherein A is one or more alkali metals selected from sodium and/or potassium, or a mixture of lithium with sodium and/or potassium; M¹ includes one or more redox active metals with an oxidation state in the range +2 to +4; M² includes tin, optionally in combination with one or more metals; M³ includes one or more transition metals either alone or in combination with one or more non-transition elements selected from alkali metals, alkaline earth metals, other metals and metalloids, with an oxidation state in the range +1 to +5; wherein the oxidation state of M¹, M², and M³ are chosen to maintain charge neutrality and further wherein δ is in the range 0≤δ≤0.4; U is in the range 0.3<U<2; V is in the range 0.1≤V<0.75; W is in the range 0<W<0.75; X is in the range 0≤X<0.5; and (U+V+W+X)<4.0.

In some embodiments, the metal ion containing material includes Li₂FeS₂, NaNiO₂, NaMO₂ where M is Co, Ni, Fe, Mn, Ti, Sn, Zr or a mixture thereof, LiFEO₂, lithium iron borate, or a mixture thereof.

The foregoing and other features of the invention are hereinafter described in greater detail with reference to the accompanying drawings.

### BRIEF DESCRIPTION OF DRAWINGS

FIG. 1A is a schematic illustration of an active material in particulate form with the particles fully coated with hydrophobic material.

FIG. 1B is a schematic illustration of an active material in particulate form with the particles partially coated with hydrophobic material.

FIG. 2A is a schematic illustration of active material in the form of particle agglomerates with the agglomerates fully coated with a hydrophobic material.

FIG. 2B is a schematic illustration of active materials in the form of particle agglomerates with the agglomerates partially coated with hydrophobic material.

FIG. 3A is a schematic illustration of active battery materials in particulate form with the particles coated with a small particle size powdered hydrophobic material.

FIG. 3B is a schematic illustration of active battery materials in the form of particle agglomerates with the agglomerates coated with a small particle size powdered hydrophobic material.

FIG. 4 is a flow chart showing an exemplary process for producing the coated metal ion battery material.

FIG. 5A shows x-ray diffraction patterns of an O3-type layered nickelate material milled with 0.5% w/w stearic acid, after exposure to the laboratory atmosphere at different time periods.

FIG. 5B shows x-ray diffraction patterns of an O3-type layered nickelate material milled with 0.5% w/w stearic acid, after exposure to the laboratory atmosphere at different time periods

FIG. 6A shows x-ray diffraction patterns of an O3-type layered nickelate material milled with 1% C65 carbon black, after exposure to the laboratory atmosphere at different time periods.

FIG. 6B shows x-ray diffraction patterns of an O3-type layered nickelate material milled with 1% C65 carbon black, after exposure to the laboratory atmosphere at different time periods.

FIG. 7A shows x-ray diffraction patterns of an O3-type layered nickelate material milled with 1% hydrophobic silica, after exposure to the laboratory atmosphere to different times.

FIG. 7B shows x-ray diffraction patterns of an O3-type layered nickelate material milled with 1% hydrophobic silica, after exposure to the laboratory atmosphere to different times.

FIG. 8 shows the sample degradation of layered oxide in air, shown by degradation vs time of x-ray diffraction 41 2 theta peak of samples with and without surface coatings.

### DETAILED DESCRIPTION OF INVENTION

Hereinafter, the embodiments of the present disclosure will be described with reference to the accompanying tables and figures.

### Coated Material

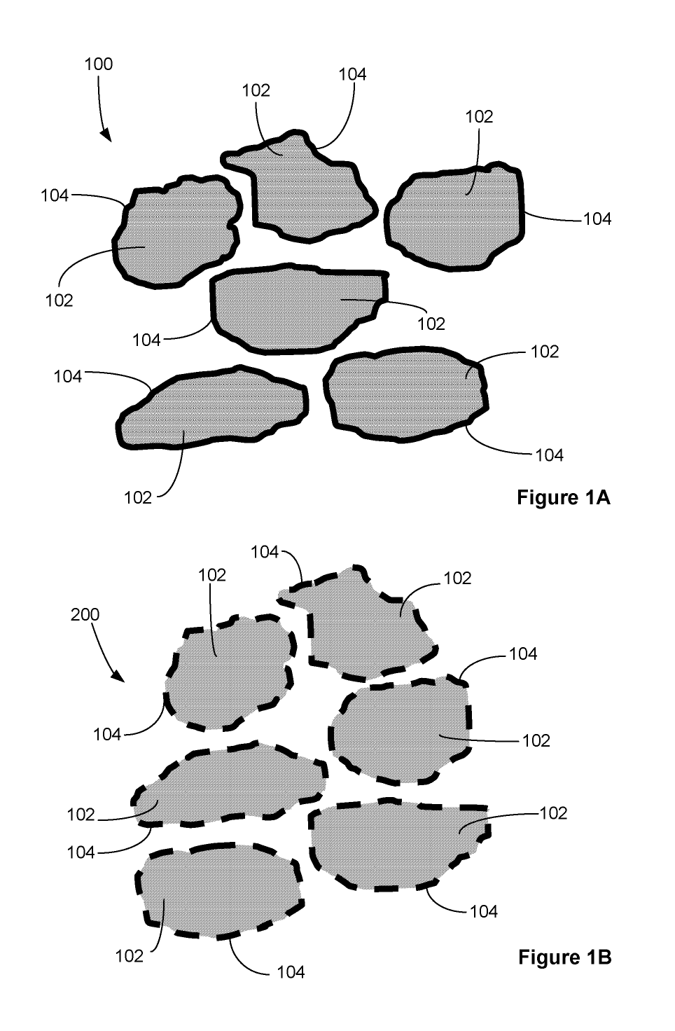

In accordance with the present disclosure, and with initial reference to FIGS. 1A and 1B, a coated metal ion containing material is shown at 100, 200, including a metal ion containing material (e.g., an active material such as a cathode or anode material) for a metal ion battery coated with a hydrophobic material. FIGS. 1A and 1B schematically show the coated metal ion containing material in particulate (e.g., powder) form. In FIG. 1A, each particulate includes a core 102 including the active material, and the surface of the core is fully coated with a hydrophobic layer 104 including one or more hydrophobic materials. For the coated metal ion containing material 200 shown in FIG. 1B, each particulate includes a core 102 including the active material, and the surface of the particulate are partially coated with a hydrophobic layer 104 including one or more hydrophobic materials. In some embodiments, the coated metal ion containing material may be present in particulate form, where a portion of the particulates are fully coated, and the other portion of the particulates are partially coated.

In the embodiments shown in FIGS. 1A and 1B, single particles of the metal ion containing material are coated with the hydrophobic material. In some embodiments, the average particle size of the particles shown in FIGS. 1A and 1B, may range from 1 μm to 20 μm. In other embodiments, the average particle size of the particles shown in FIGS. 1A and 1B, may range from 1 μm to 10 μm. In other embodiments, the average particle size of the particles shown in FIGS. 1A and 1B, may be about 5 μm. In some embodiments of the active material shown in FIGS. 1A and 1B, the size of the particles may range between 10 nm and 100 μm. In some embodiments, the coating thickness of the hydrophobic layer 104 in FIGS. 1A and 1B may range from 0.01 nm to 10 nm. In some embodiments of the partially coated particulates, the respective particles have at least 50% of their surface coated.

As described below, the coated particles may be formed by combining the metal ion containing material (e.g., active material such as a cathode or anode material) with one or more hydrophobic materials at the milling process of the active material. For example, in some embodiments, the metal ion containing material (e.g., particles, powder) may be milled with the hydrophobic material(s) (e.g., stearic acid) in a ball mill for a specified amount of time. Depending upon the mixing method and time, different levels of coatings may occur. The material which contains a full surface coating may have a greater stability compared to the partial surface coatings. In some embodiments, the full surface coating may be achieved by the addition of a solvent during the mixing process, either by milling with a small amount of solvent or by subsequently dispersing the milled mixture in a solvent. The solvent can then be removed by drying (e.g., vacuum drying).

The coated material can possess prolonged stability to air by the addition of the hydrophobic additive. This may be particularly important in the context of sodium-ion containing materials, which can be much more reactive to water compared to the lithium counterparts. The sodium-ion containing materials may decompose and/or may also chemically intercalate water into its structure. As compared with the lithium counterparts, the maximum temperature for drying the sodium-ion containing material (up to ˜140° C.) is not adequate to remove the chemically bound water or reverse the decomposition process. In addition to material stability, the absorbed and adsorbed water can have a negative effect upon the properties of an ink, and in basic environments, gelling of the binding agent contained within a cathode ink or paste may occur. Sodium is much more basic than the lithium layered oxides and therefore stability of the inks is also an issue which can be improved by stabilising the cathode powder. The coated material may repel the water from the atmosphere rather than absorb it. This may result in a greater degree of stability of the cathode materials in air. In some embodiments where the cathode is made into a composite ink for coating with a binder and conductive carbon additive, the ink may have a greater degree of stability in air and the gelling of the binder may be delayed.

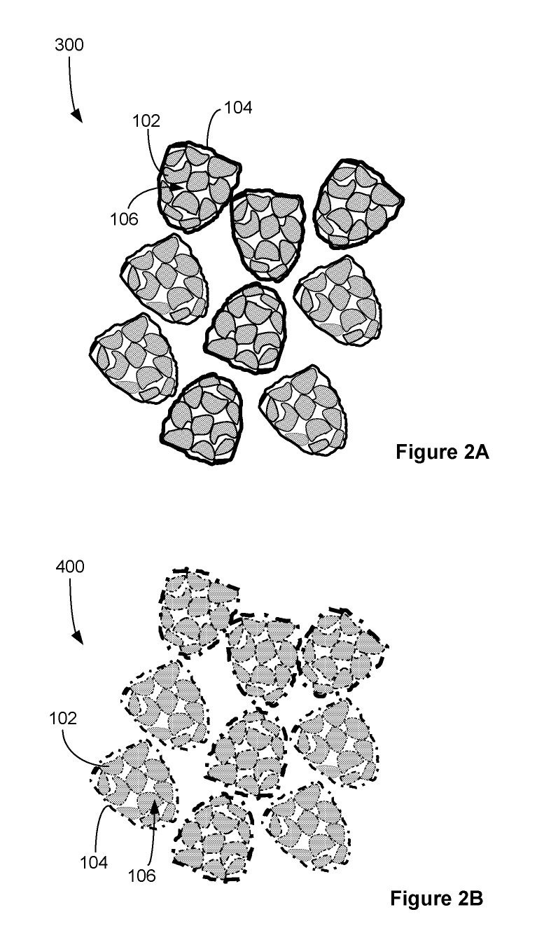

In the exemplary embodiments shown in FIGS. 1A and 1B, the core of the coated metal ion containing material is embodied as a single particle. With additional reference to FIGS. 2A and 2B, in some embodiments, the core of the coated metal ion containing material 300, 400 is embodied as an agglomerate of particles. This agglomerate of active materials may be coated with the hydrophobic layer. FIGS. 2A and 2B schematically shows the coated active material 300, 400 in particulate (e.g., powder) form, where the metal ion containing material is an agglomeration of primary particles 102 to produce a larger secondary particle 106. In FIG. 2A, each particulate includes a core including the metal ion containing material 102, with the core being an agglomeration 106 of primary particles. The surface of the core is fully coated with a hydrophobic layer 104 including one or more hydrophobic materials. In FIG. 2B, each particulate includes a core including the metal ion containing material, with the core being an agglomeration 106 of primary particles 102. The surface of the particulate are partially coated with a hydrophobic layer 104 including one or more hydrophobic materials. In some embodiments, a portion of the agglomerations are fully coated, and the other portion of the agglomerations are partially coated.

As described below, the coated particles may be formed by combining the metal ion containing material (e.g., active material such as a cathode or anode material) with one or more hydrophobic materials at the milling process of the metal ion containing material. The formation of the agglomerations of metal ion containing material may depend on one or more factors such as the properties/composition of the powder, the size of the particles used in the process, and/or the process by which the metal ion containing material was made.

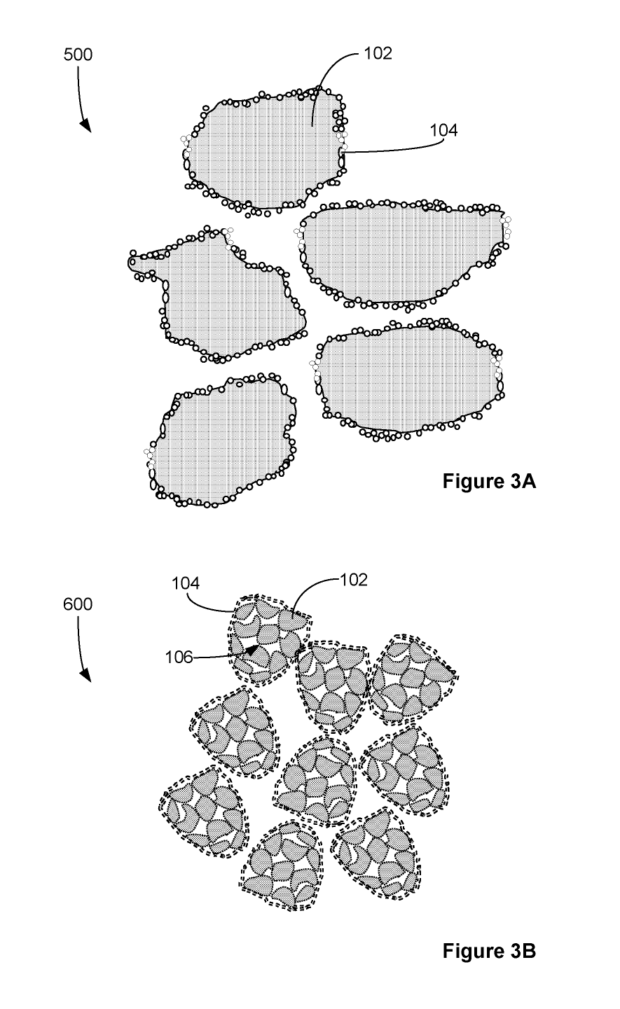

FIGS. 1 and 2 show respective embodiments in which the single particles are coated with the hydrophobic layer and in which particle agglomerates are coated with the hydrophobic layer. In some embodiments, the coated material may be a combination of the single particles coated with the hydrophobic material (FIGS. 1A and 1B) and particle agglomerates coated with the hydrophobic material (FIGS. 2A and 2B). In the exemplary embodiments shown in FIGS. 1 and 2, the hydrophobic layer is shown as a layer at the surface of the particle or agglomerate. In some embodiments, and with reference to the coated active material 500, 600 shown in FIGS. 3A and 3B, the coating on the particle or agglomerate may be embodied as small particle size powdered hydrophobic material. In some embodiments, hydrophobic nanomaterials may be used to coat the metal ion containing material particles or agglomerates, and here the nano particles coat the larger active materials and repel the water from the surface. As an example, the active powder may be ball milled for 1 hour at 400 rpm together with a nano sized powder such as a nano-zeolite. The different materials are produced depending on the ratio of the hydrophobic material relative to the active material, their relative sizes, and the mixing method such as the mixing type, speed, and duration.

The metal ion containing material (active material) may be any suitable metal ion containing material, such as a layered oxide material. Examples of the metal ion containing material include sodium-ion materials, potassium ion materials, and lithium-ion materials. The metal ion containing material may be, for example, a cathode material or an anode material.

Exemplary metal ion containing materials (cathode) include those represented by Chemical Formula (1):

Au M¹v M²w M³x O_{2±δ}

wherein

A is one or more alkali metals selected from sodium and/or potassium, or a mixture of lithium with sodium and/or potassium;

M¹ includes one or more redox active metals with an oxidation state in the range +2 to +4;

M² includes tin, optionally in combination with one or more metals;

M³ includes one or more transition metals either alone or in combination with one or more non-transition elements selected from alkali metals, alkaline earth metals, other metals and metalloids, with an oxidation state in the range +1 to +5;

wherein

the oxidation state of M¹, M², and M³ are chosen to maintain charge neutrality and further wherein

δ is in the range 0≤δ≤0.4;

U is in the range 0.3<U<2;

V is in the range 0.1≤V<0.75;

W is in the range 0<W<0.75;

X is in the range 0≤X<0.5;

and (U+V+W+X)<4.0.

Other examples of metal ion containing materials (cathode) include Li₂FeS₂, NaNiO₂, NaMO₂ where M is Co, Ni, Fe, Mn, Ti, Sn, Zr or a mixture thereof, LiFEO₂, lithium iron borate, or a mixture thereof.

Exemplary metal ion containing materials (anode) include tin, tin alloys, silicon, hard carbon, and graphite.

Exemplary hydrophobic materials include carboxylic acids such as fatty acids. Examples include stearic acid, oleic acid, palmitic acid, myristic acid, oxalic acid, maleic acid, and their salts. More specific examples include calcium stearate, sodium stearate, sodium mysterate, zinc stearate, cesium oxalate, cesium stearate, potassium oxalate, potassium stearate. In some embodiments, such exemplary hydrophobic materials may form the coating or partial coating shown in FIGS. 1A, 1B, 2A, and 2B.

Other exemplary hydrophobic materials include silicas, aluminas, and/or zeolites. Examples include hydrophobic nano silica, hydrophobic nano alumia, hydrophobic zeolites (e.g., zeolites and/or nano zeolites). In some embodiments, such exemplary hydrophobic materials may form the powder coating shown in FIGS. 3A and 3B.

Other exemplary hydrophobic materials include silicon-based oils such as silanol, silanes. Other exemplary hydrophobic materials include hydrophobic polymers such as PTFE, PVDF, decanol, polyvinylpyrrolidone, poly(vinylpyridine), polyacrylates, polymethylacrylate, and sodium acrylate.

In some embodiments, the hydrophobic powder additive may be combined with an additive such as carbon nanotubes, carbon black, and/or graphite.

### Production Method

In accordance with the present application, one or more hydrophobic materials are added in at the milling process of the metal ion containing material (e.g., cathode or anode material). With introduction of the one or more hydrophobic materials at the milling process, the one or more hydrophobic materials may be coated on the active material as a hydrophobic layer. This coated active material (e.g., in particulate/powder form) may possess prolonged stability to air by the addition of the hydrophobic additive. The water from the atmosphere may be repelled rather than absorbed by the coated material. This may result in a greater degree of stability of the active materials in air.

In some embodiments, the coated metal ion containing material is made into a composite ink for coating by combining the coated metal ion containing material with a binder and conductive carbon additive. These inks also may have a greater degree of stability in air and resistance to gelling of the binder.

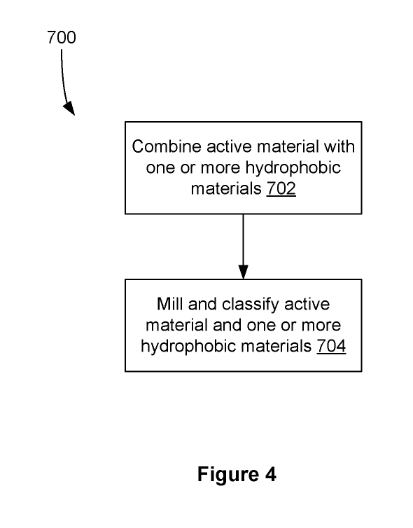

FIG. 4 shows an exemplary production method 700 by which the coated material of the present disclosure may be produced. At step 702, the one or more hydrophobic materials are added to one or more metal ion containing materials (e.g., cathode or anode materials). The hydrophobic material may be added in any suitable amount. In some embodiments, a total of amount of the one or more hydrophobic coating materials is combined in an amount of 0.001 wt % to 5 wt % of the metal ion containing material. In other embodiments, a total of amount of the one or more hydrophobic coating materials is combined in an amount of 0.01 wt % to 1 wt % of the metal ion containing material. In other embodiments, a total of amount of the one or more hydrophobic coating materials is combined in an amount of about 0.1 wt % of the metal ion containing material.

The one or more metal ion containing materials (active material) may be any suitable material for use, for example, as a cathode or anode. The particular manner in which the active material is produced is not necessarily germane to the present disclosure, and will not be described in detail. But one exemplary process of producing a cathode material used as the active material is produced by solid state synthesis. In the solid state synethesis process, required amounts of precursor materials may be intimately mixed together, heated in a furnace (e.g., at a furnace temperature of between 400° C. and 1500° C.) using either an ambient air atmosphere or a flowing inert atmosphere (e.g. argon or nitrogen) until reaction product forms, and cooled. As described above, the manner in which the metal ion containing material is produced may yield the agglomerates.

The one or more hydrophobic materials may be any suitable material.

At step 704, the combined one or more hydrophobic materials and one or more metal ion containing materials are milled and classified to the correct tap density and particle size distribution for the optimum properties when in an electrode. Mixing may take place at room temperature (e.g., 20° C. and 30° C.), or at elevated temperatures (e.g., between 30° C. and 1000° C.). In one example, mixing may take place between 20° C. and 80° C. Mixing of the metal ion containing material and additives may be by a suitable method such as pestle and mortar, ball milling, bead milling, vibromilling, or in a fluidised bed; and may be conducted for any suitable time (e.g., 1 minute to 12 hours; in other embodiments 1 minute to 1 hour). In one example, milling may be performed in a ball mill at 400 rpm for 1 hour. Mixing may be performed in addition with a solvent such as TMB, dry NMP, hexanol, ethanol, methanol, IPA, dodecanol. In some embodiments, the mixing may be performed with a surfactant additive. In an example, the surfactant may be tergitol, and it may be provided in an amount from 0.1 wt % to 1 wt %. During this milling and classification, the one or more hydrophobic materials coats the one or more metal ion containing materials with a hydrophobic coating and thus may stabilise the powder to decomposition. In some embodiments, agglomeration may depend on factors such as material, particle size, milling time and conditions and any additives. Providing a partial versus a full coating may depend on factors such as milling time, quantity of coating material and degree of agglomeration of the metal ion containing material.

Subsequently, the powder can be processed into an electrode for an electrochemical cell. One exemplary process for producing the electrode is a solvent-casting technique. In one embodiment, the stabilised active material can be used to make an electrode slurry with conductive additive and binder.

### EXAMPLES

### Example 1

### Cathode Sodium-Ion, Stearic Acid

50 g of NaNi_{1/2}Mn_{1/4}Sn_{1/8}Ti_{1/8}O₂ is placed into a polypropylene container with 20 g of 10 mm diameter zirconia balls in a glove box. To this 0.25 g of stearic acid is added. The container is sealed and transferred to a roller mill for 4 hours. The milling media is then removed from the container in a dry room and the powder is used in a cathode electrode as the active material.

### Example 2

### Cathode Sodium-Ion, Hydrophobic Silica

50 g of NaNi_{1/2}Mn_{1/4}Sn_{1/8}Ti_{1/8}O₂ is placed into a polypropylene container with 20 g of 10 mm diameter zirconia balls in a glove box. To this 0.5 g of hydrophobic nano silica is added. The container is sealed and transferred to a roller mill for 4 hours. The milling media is then removed from the container in a dry room and the powder is used in a cathode electrode as the active material.

### Example 3

### Cathode Sodium-Ion, Hydrophobic Silica and Carbon Nano Tubes

50 g of active cathode material, NaMn_{0.5}Ni_{0.5}O₂ is placed into a glass flask. To this 0.25 g of hydrophobic silica and 0.25 g of multi walled carbon nano tubes and 200 ml of NMP are added. The flask is sealed and then sonicated for 4 hours in an ultrasonic bath. Upon retrieval, the dispersion is dried under vacuum and the powder is collected.

### Example 4

### Cathode Sodium-Ion, Sodium Stearic Acid

50 g of NaNi_{1/2}Mn_{1/4}Sn_{1/8}Ti_{1/8}O₂ is placed into a polypropylene container with 20 g of 10 mm diameter zirconia balls in a glove box. To this 0.3 g of sodium stearate and 1 ml of NMP is added. The container is sealed and transferred to a roller mill for 4 hours. The milling media is then removed from the container in a dry room and the powder is used in a cathode electrode as the active material after drying in a vacuum oven at 80° C. overnight.

### Example 5

### Zeolite/Carbon Black and Cathode Sodium-Ion Powders

50 g of active cathode material NaNi_{1/3}Mn_{1/3}Mg_{1/6}Ti_{1/6}O₂ is placed into a zirconia ball mill pot. To this 0.25 g of hydrophobic zeolite, 0.25 g of C65 carbon black, 2 pipette drops of TMB and 10 g 10 mm balls are added. The mixture is milled at 250 rpm for 1 hour.

### Example 6

### Sodium Iron Borate Materials, Calcium Stearate, Milling

50 g of active cathode material NaFeBO₃ was placed into a zirconia ball mill pot, to this 0.5 g of calcium stearate was added and 10 g 10 mm balls. The mixture is milled for 250 rpm for 1 hour.

### Example 7

### Lithium Iron Silicate, Stearic Acid, Carbon Black, Milling

50 g of active cathode material Li₂FeSiO₄ is placed into a zirconia ball mill pot. To this 0.3 g of myrystic acid, 0.2 g of carbon black C65, and 10 g 10 mm balls are added. The mixture is milled for 120 rpm for 4 hours.

### Example 8

### Sn Powder Alloy, Stearic Acid, Carbon Black, Milling

50 g of Sn nano powder (200-400 nm) is placed into a glass flask. To this 0.5 g of stearic acid, 0.25 g of multi walled carbon nano tubes and 200 ml of NMP are added. The flask is sealed and then sonicated for 4 hours in an ultrasonic bath. Upon retrieval, the dispersion is dried under vacuum and the powder collected.

### Electrode and Test Cell Preparation

For each of Examples 1-8, the material produced is used to prepare a cast electrode. Each sample is prepared from a slurry using a solvent-casting technique. The conductive carbon used in the slurry is Super P C65, manufactured by Timcal. The binder used in the slurry is polyvinylidene fluoride (PVDF). The solvent used in the slurry is N-Methyl-2-pyrrolidone (NMP), Anhydrous, manufactured by Sigma. The slurry is prepared by weighing the active and conductive materials in a container, to which a binder solution is then added. This composite is then mixed using a dual asymmetric mixer (Thinky) for 10 minutes at 1100 rpm. A Typical slurry mix contains ratios of active material:conductive carbon:binder, 89:5:6 expressed as percentage weight, dispersed in an appropriate quantity of NMP. The slurry is then cast onto an aluminium current collector using the Doctor-blade technique. The formed cast electrode is then dried under Vacuum at about 80-120° C. for about 4 hours. As formed, each electrode film contains the following components, expressed in percent by weight: 89% active material, 5% Super P carbon, and 6% PVDF binder. Optionally, this ratio can be varied (e.g., by adjusting the amounts of the components in the slurry) to optimize the electrode properties such as, adhesion, resistivity and porosity.

The electrolyte is provided as a solution of NaPF₆ in ethylene carbonate and diethylene carbonate solvent 0.5:0.5. In some embodiments, the electrolyte is also provided as a 0.5 M solution of NaClO₄ in PC. In other embodiments, the electrolyte is provided as a 1.0 M solution of NaClO₄ in PC. In still other embodiments, the electrolyte can be any suitable or known electrolyte or mixture thereof. Examples include alternative sodium salts such as NaPF₆ in carbonate based solvents, ionic liquids, polymer electrolytes or solid state electrolytes.

In some embodiments, a glass fiber separator is interposed between the positive and negative electrodes forming the electrochemical test cell. One example of a suitable glass fiber separator is a Whatman grade GF/A separator. In other embodiments, a porous polypropylene or a porous polyethylene separator wetted by the electrolyte is interposed between the positive and negative electrodes forming the electrochemical test cell. One example of a suitable porous polypropylene separator is Celgard 2400.

### Cell Testing:

The electrochemical cell was cycled at a current density of 10 mA/g between pre-set voltage limits as deemed appropriate for the material under test. Appropriate voltage limits are determined experimentally for each sample and are within the electrochemical stability window of the electrolyte. The voltage window stability is typically 4.2V-1.5V Vs Na/Na⁺. Other voltage limits may be used, for example 4.3V-2.0V Vs Na/Na⁺. A commercial battery cycler from Maccor Inc. (Tulsa, Okla., USA) was used to collect data. Cells were charged symmetrically between the upper and lower voltage limits at a constant current density. On charge, metal ions are extracted from the cathode and migrate to the anode. On discharge the reverse process occurs and sodium ions are re-inserted into the cathode material.

### Structural Characterization:

All of the product materials were analyzed by X-ray diffraction techniques using a Bruker D2 Phaser powder diffractometer (fitted with a Lynxeye™ detector) to confirm that the desired target materials had been prepared, to establish the phase purity of the products, and to determine the types of impurities present. From this information it is possible to determine the unit cell lattice parameters.

The operating conditions used to obtain the powder X-ray diffraction patterns illustrated using powdered as made materials, are as follows:

Range: 2θ=10°-70°

X-ray Wavelength=1.5418 Å (Angstoms) (Cu Kα)

Step size: 2θ=0.02

Speed: 1.5 seconds/step

### Stability Testing

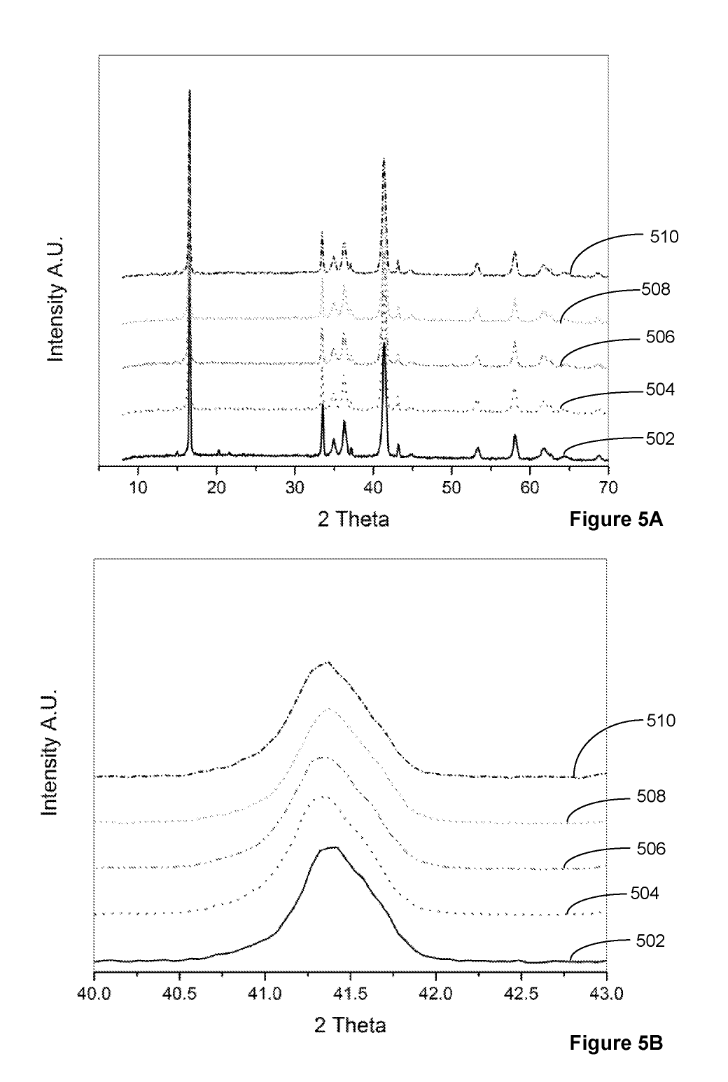

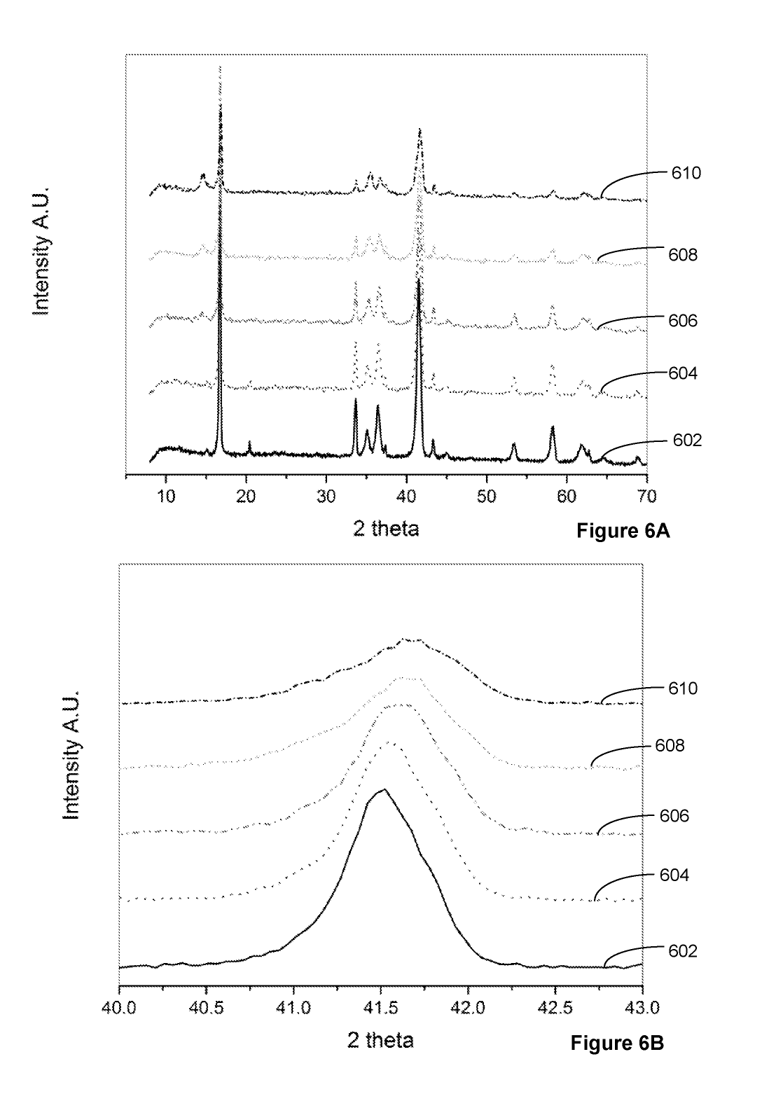

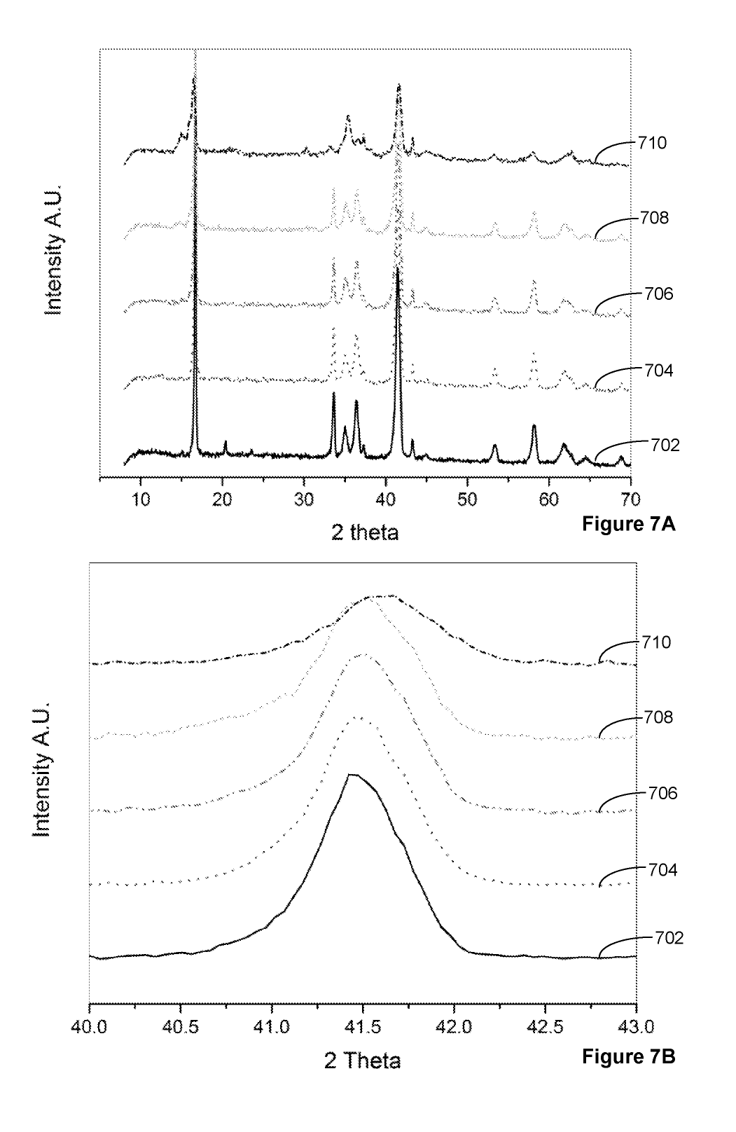

Samples of coated and uncoated metal ion containing materials were tested for stability to the atmosphere by taking an initial XRD pattern measurement, and then exposing the material to the laboratory atmosphere for a noted period of time, and repeating the x-ray diffraction measurement. The peak heights of the XRD pattern measurement dropped as the material decomposed and reacted with the water in the air, and examples of this drop over time are shown in FIGS. 5-7. The coated particles exhibited a reduction in the dropping of the peak heights over time, in some embodiments even after two weeks exposure to the Lab atmosphere (e.g., the examples shown in FIGS. 5A, 5B, 7A, and 7B show a reduction in the dropping of the peak heights over one week). By contrast, particles that were not coated or that were coated only with comparative materials (e.g., such as that exhibited in the example shown in FIGS. 6A and 6B) were found to decompose very fast compared to the coated particles. In some embodiments, almost complete decomposition of the uncoated structure occurred in 2.5 hours from exposure to ambient laboratory atmosphere.

FIGS. 5A and 5B show the x-ray diffraction patterns of an O3-type layered nickelate material milled with 0.5% w/w stearic acid, at an initial measurement (502—initial measurement at 0 hours) and after exposure to the laboratory atmosphere to different times (504—measurement at 2.5 hours; 506—measurement at 4 hours; 508—measurement at 6.5 hours; 510—measurement at 1 week). The different measurements are superimposed on the same graph so the magnitude of the respective peaks can be directly compared. While some minor reduction of the peaks can be seen over time, the material even after one week exposure to the lab atmosphere is shown to be in tact with little degradation.

FIGS. 6A and 6B show the x-ray diffraction patterns of an O3-type layered nickelate material milled with 1% C65 carbon black, at an initial measurement (602—initial measurement at 0 hours) and after exposure to the laboratory atmosphere to different times (604—measurement at 1 hour; 606—measurement at 2.5 hours; 608—measurement at 5 hours; 610—measurement at 6 hours). The different measurements are superimposed on the same graph so the magnitude of the respective peaks can be directly compared. As contrasted with FIGS. 5A and 5B, it can be seen from the reduction in peaks in FIGS. 6A and 6B that the decomposition of this material is very fast. Almost complete decomposition of the O3-type layered structure has occurred in 6 hours with exposure to ambient laboratory atmosphere.

FIGS. 7A and 7B show the x-ray diffraction patterns of an O3-type layered nickelate material milled with 1% hydrophobic silica, at an initial measurement (702—initial measurement at 0 hours) and after exposure to the laboratory atmosphere to different times (704—measurement at 1.5 hours; 706—measurement at 3 hours; 708—measurement at 5 hours; 710—measurement at 1 week). The different measurements are superimposed on the same graph so the magnitude of the respective peaks can be directly compared. The results show the improved stability of an O3-type layered oxide material when milled with SiO₂ nano powder. The degradation of the x-ray diffraction pattern is reduced, and the material is shown to have a greater stability to the lab atmosphere compared to FIGS. 6A and 6B.

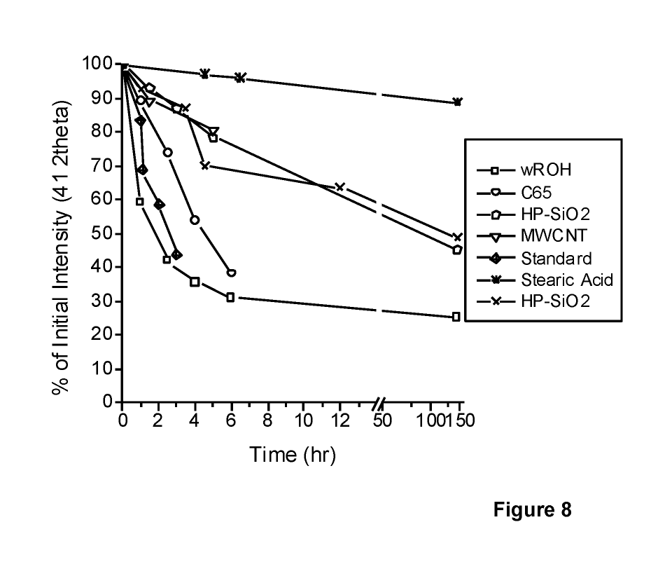

FIG. 8 shows the sample degradation of layered oxide in air, shown by degradation vs time of x-ray diffraction 41 2 theta peak of samples with and without surface coatings. It is shown that most additives (carbon nano tubes, carbon black, hydrophobic silica and stearic acid) have an effect upon the degradation of the layered oxide material in air, as compared with the uncoated sample (standard). The best stability was shown to be provided by the stearic acid coatings of the powders.

### INDUSTRIAL APPLICABILITY

Coated metal ion containing materials of the present disclosure are suitable for use in many different applications, energy storage devices, rechargeable batteries, electrochemical devices and electrochromic devices.

1. A coated metal ion containing material, comprising:
a core comprising a metal ion containing material; and
a hydrophobic coating at least partially coating the core, wherein the hydrophobic coating comprises one or more of a carboxylic acid, silica, alumina, zeolite, silicon-based oil, and hydrophobic polymer.

2. The coated metal ion containing material of claim 1, wherein the core is a single particle.

3. The coated metal ion containing material of claim 1, wherein the core is an agglomerate of particles.

4. The coated metal ion containing material of claim 1, wherein the coating partially covers the core.

5. The coated metal ion containing material of claim 4, wherein at least 50% of a surface of the core is covered by the hydrophobic coating.

6. The coated metal ion containing material of claim 1, wherein the coating completely covers the core.

7. The coated metal ion containing material of claim 1, wherein a thickness of the hydrophobic coating is 0.01 nm to 10 nm.

8. The coated metal ion containing material of claim 1, wherein the hydrophobic coating comprises one or more of stearic acid, oleic acid, palmitic acid, myristic acid, oxalic acid, maleic acid, and salts thereof.

9. The coated metal ion containing material of claim 1, wherein the hydrophobic coating comprises one or more of calcium stearate, sodium stearate, sodium mysterate, zinc stearate, cesium oxalate, cesium stearate, potassium oxalate, and potassium stearate.

10. The coated metal ion containing material of claim 1, wherein the hydrophobic coating comprises one or more of hydrophobic nano silica, hydrophobic nano alumia, and hydrophobic zeolite.

11. The coated metal ion containing material of claim 1, wherein the metal ion containing material is represented by Chemical Formula (1):
Au M¹v M²w M³x O_{2±δ}
wherein
A is one or more alkali metals selected from sodium and/or potassium, or a mixture of lithium with sodium and/or potassium;
M¹ includes one or more redox active metals with an oxidation state in the range +2 to +4;
M² includes tin, optionally in combination with one or more metals;
M³ includes one or more transition metals either alone or in combination with one or more non-transition elements selected from alkali metals, alkaline earth metals, other metals and metalloids, with an oxidation state in the range +1 to +5;
wherein
the oxidation state of M¹, M², and M³ are chosen to maintain charge neutrality and further wherein
δ is in the range 0≤δ≤0.4;
U is in the range 0.3<U<2;
V is in the range 0.1≤V<0.75;
W is in the range 0<W<0.75;
X is in the range 0≤X<0.5;
and (U+V+W+X)<4.0.

12. The coated metal ion containing material of claim 1, wherein the metal ion containing material comprises Li₂FeS₂, NaNiO₂, NaMO₂ where M is Co, Ni, Fe, Mn, Ti, Sn, Zr or a mixture thereof, LiFEO₂, lithium iron borate, or a mixture thereof.

13. A method of forming a coated metal ion containing material, comprising:
combining the metal ion containing material and one or more hydrophobic coating materials, wherein the one or more hydrophobic coating materials comprises one or more of a carboxylic acid, silica, alumina, zeolite, silicon-based oil, and hydrophobic polymer; and
milling the metal ion containing material and the one or more hydrophobic coating materials to coat the metal ion containing material with the one or more hydrophobic coating materials to provide a core comprising the metal ion containing material and a hydrophobic coating at least partially coating the core.

14. The method of claim 13, wherein a total of amount of the one or more hydrophobic coating materials is combined in an amount of 0.001 wt % to 5 wt % of the metal ion containing material.

15. The method of claim 13, further comprising combining a surfactant with the metal ion containing material and the one or more hydrophobic coating materials.

16. The method of claim 13, wherein the one or more hydrophobic coating materials comprises one or more of stearic acid, oleic acid, palmitic acid, myristic acid, oxalic acid, maleic acid, and salts thereof.

17. The method of claim 13, wherein the one or more hydrophobic coating materials comprises one or more of calcium stearate, sodium stearate, sodium mysterate, zinc stearate, cesium oxalate, cesium stearate, potassium oxalate, and potassium stearate.

18. The method of claim 13, wherein the one or more hydrophobic coating materials comprises one or more of hydrophobic nano silica, hydrophobic nano alumia, and hydrophobic zeolite.

19. The method of claim 13, wherein the metal ion containing material is represented by Chemical Formula (1):
Au M¹v M²w M³x O_{2±δ}
wherein
A is one or more alkali metals selected from sodium and/or potassium, or a mixture of lithium with sodium and/or potassium;
M¹ includes one or more redox active metals with an oxidation state in the range +2 to +4;
M² includes tin, optionally in combination with one or more metals;
M³ includes one or more transition metals either alone or in combination with one or more non-transition elements selected from alkali metals, alkaline earth metals, other metals and metalloids, with an oxidation state in the range +1 to +5;
wherein
the oxidation state of M¹, M², and M³ are chosen to maintain charge neutrality and further wherein
δ is in the range 0≤δ≤0.4;
U is in the range 0.3<U<2;
V is in the range 0.1≤V<0.75;
W is in the range 0<W<0.75;
X is in the range 0≤X<0.5;
and (U+V+W+X)<4.0.

20. The method of claim 13, wherein the metal ion containing material comprises Li₂FeS₂, NaNiO₂, NaMO₂ where M is Co, Ni, Fe, Mn, Ti, Sn, Zr or a mixture thereof, LiFEO₂, lithium iron borate, or a mixture thereof.
